(19) United States
(12) Patent Application Publication
(10) Pub. No.: US 2016/0132915 A1
(43) Pub. Date: May 12, 2016

(54) ASSESSING VALUE OF A BRAND BASED ON ONLINE CONTENT

(71) Applicant: HEWLETT-PACKARD DEVELOPMENT COMPANY, L.P., Houston, TX (US)

(72) Inventors: Vinayak Puranik, Bangalore Karnataka (IN); Geetha Manjunath, Bangalore Karnataka (IN)

(21) Appl. No.: 14/897,271

(22) PCT Filed: Jun. 27, 2013
(86) PCT No.: PCT/IN2013/000398

§ 371 Date: Dec. 10, 2015

(51) Int. Cl. G06Q 30/02; G06Q 50/00

(52) U.S. Cl. CPC G06Q 30/0206; G06Q 50/01

(57) ABSTRACT

Provided is a method for assessing value of a brand based on online content. Content related to a brand is captured from the internet. Captured content is quantitatively analyzed to determine a first brand value of the brand. Captured content is filtered to extract subject matter relevant to the brand. The extracted subject matter is evaluated to determine a second brand value of the brand. The first brand value and the second brand value are combined to determine value of the brand.

### BACKGROUND

The Internet is emerging as de facto platform for people to express their opinions, ideas and creative expressions. Whether it is politics, technology, finance, sports, or entertainment, it takes just a few minutes for people to share their thoughts on a subject matter with a million other individuals. Thus, social media which is generally referred to as a means of interaction by which people share, discuss and exchange information and ideas in virtual communities has become one of the most common tools of human expression.

### BRIEF DESCRIPTION OF THE DRAWINGS

For a better understanding of the solution, embodiments will now be described, purely by way of example, with reference to the accompanying drawings, in which:

FIG. 1 is a schematic diagram of a representative system for assessing value of a brand based on online content, according to an example.

FIG. 2 shows a block diagram of a brand value assessment module hosted on a computer system, according to an example.

FIG. 3 illustrates components of brand value assessment module, according to an example.

FIG. 4 illustrates a flow chart of a method for assessing value of a brand based on online content, according to an example.

FIG. 5 illustrates architecture of a filtering module used to extract key influential statements from captured content, according to an example.

FIG. 6 illustrates determination of a second brand value of a brand, according to an example.

FIG. 7 illustrates a table summarizing brand impression analysis based on metric values, according to an example.

### DETAILED DESCRIPTION OF THE INVENTION

Social media technologies provide an important platform for individuals to express themselves online. Some common examples of social media technologies include: social networks, blogs, Internet forums, wikis, weblogs, social blogs, and podcasts. Facebook, Twitter, YouTube, Pinterest, etc. are examples of some well-know social media platforms.

As mentioned earlier, it has become quite easy for individuals to express themselves in an online environment, for instance, by using a social media platform.

Apart from individuals, corporate enterprises, firms and other business organizations have also grabbed the opportunity, which the platform offers, to market and reach out to consumers in different ways. Businesses are increasingly realizing the importance of analyzing the social media data to understand not only the consumer sentiments and requirements that are explicitly expressed on various social media channels, but also the implicit public perceptions or impressions of their “brand” in order to fine tune their marketing and business strategies. They are thus interested in knowing the impact that their brand creates on a large section of people.

Proposed is solution that that uses online content related to a brand (for example, posted in social media) to determine how end customers and the general public perceive the value that a brand brings to them. Proposed solution assesses the value of a brand based on the impressions created on the minds of the end customers or potential customers. In an example, this brand impression is assessed for different value-adding attributes of the brand.

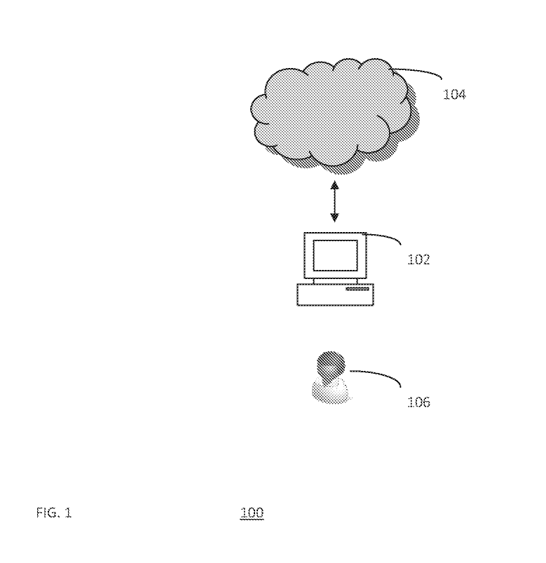

FIG. 1 is a schematic diagram of a representative system for assessing value of a brand based on online content, according to an example. System infrastructure 100 comprises of computer system 102 connected to network 104. In an example, there may be additional computer systems connected to network 104. Computer system 102 may connect to network 104 through physical wiring (for example, via co-axial cable) or wirelessly (for example, via Wi-Fi).

Computer system 102 may be a desktop computer, notebook computer, tablet computer, mobile phone, personal digital assistant (PDA), smart phone, server computer, and the like. Network 104 may be a private network (such as a local area network (LAN)) or a public network (such as the Internet). Network 104 may host a variety of content such as text, audio, video, animation, multimedia, etc. In an example, aforementioned content may relate to a “brand”, which may be owned by an enterprise such as a firm, company, Limited Liability Partnership (LLP), government or non-government body etc. Also, in an example, content on network 104 may be hosted, shared, exchanged, or posted on a social media platform such as, but not limited to, social networks, blogs, internet forums, wikis, weblogs, social blogs, and podcasts.

In an example, computer system 102 is used by user 106. In another example, however, there may be a plurality of computer systems connected to network 104. In such case, various users who may be co-located or located independent of each other (for instance, at different geographical locations) may use said computer systems to connect to network 104. In an implementation, user 106 provides his or her rating on a predefined brand assessment attribute through computer system 102. At the time of rating, the name of the brand, which is being rated against a brand assessment attribute, may be visible or hidden from the user.

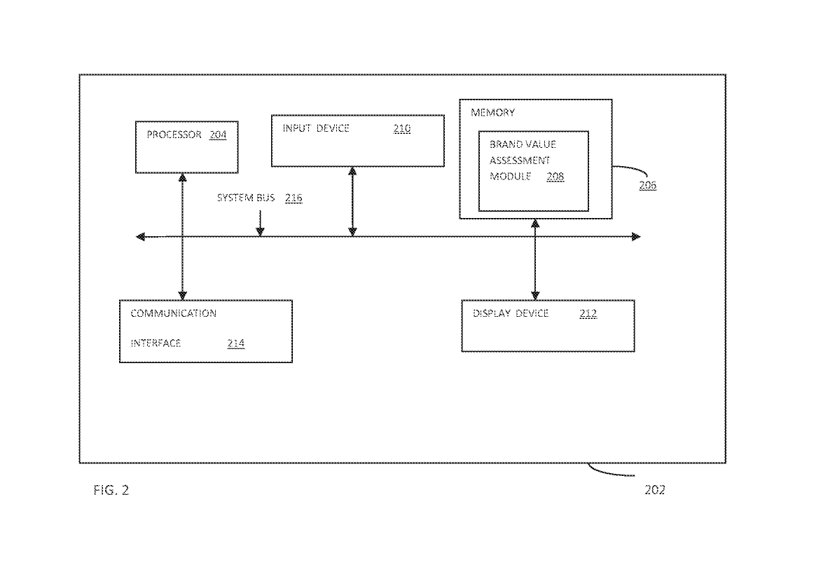

FIG. 2 shows a block diagram of a brand value assessment module hosted on a computer system, according to an example.

Computer system 202 may be a computer server, desktop computer, notebook computer, tablet computer, mobile phone, personal digital assistant (PDA), or the like. In an example, computer system 202 may be computer system 102 of FIG. 1.

Computer system 202 may include processor 204, memory 206, brand value assessment module 208, input device 210, display device 212, and a communication interface 214. The components of the computing system 202 may be coupled together through a system bus 216.

Processor 204 may include any type of processor, microprocessor, or processing logic that interprets and executes instructions.

Memory 206 may include a random access memory (RAM) or another type of dynamic storage device that may store information and instructions non-transitorily for execution by processor 204. For example, memory 206 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 206 may include instructions that when executed by processor 204 implement brand value assessment module 208.

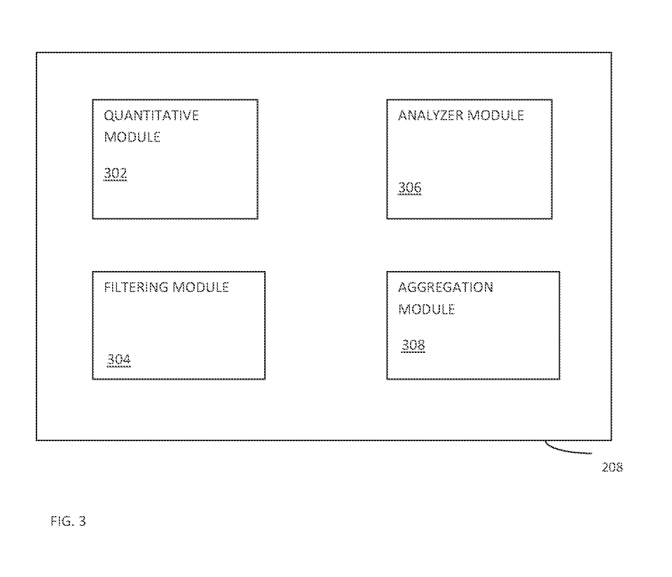

FIG. 3 illustrates components of brand value assessment module 208, according to an example. Brand value assessment module 208 comprises quantitative module 302, filtering module 304, analyzer module 306, and aggregation module 308. Quantitative module 302 may be used to perform quantitative analysis (i.e. obtaining various kinds of metrics) related to online content. Filtering module 304 is used to filter captured online content in order to extract subject matter relevant to a brand. Filtering helps in identifying key influential statements from captured content. Analyzer module 306 is used for evaluating an extracted subject matter against a predefined brand assessment attribute for determining a second brand value of the brand. Aggregation module 308 is used for combining a first brand value of the brand and a second brand value of the brand for determining a “complete” value of the brand.

Brand value assessment module 208 may he implemented in the form of a computer program product including computer-executable instructions, such as program code, which may be run on any suitable computing environment in conjunction with a suitable operating system, such as Microsoft Windows, Linux or UNIX operating system. In an implementation, brand value assessment module 208 may be installed on a computer system. In a further implementation, brand value assessment 208 may be read into memory 206 from another computer-readable medium, such as data storage device, or from another device via communication interface 216.

Input device 210 may include a keyboard, a mouse, a touch-screen, or other input device. Display device 212 may include a liquid crystal display (LCD), a light-emitting diode (LED) display, a plasma display panel, a television, a computer monitor, and the like.

Communication interface 214 may include any transceiver-like mechanism that enables computing device 202 to communicate with other devices and/or systems via a communication link. Communication interface 214 may be a software program, a hard ware, a firmware, or any combination thereof. Communication interface 214 may provide communication through the use of either or both physical and wireless communication links. To provide a few non-limiting examples, communication interface 214 may be an Ethernet card, a modem, an integrated services digital network (“ISDN”) card, etc.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

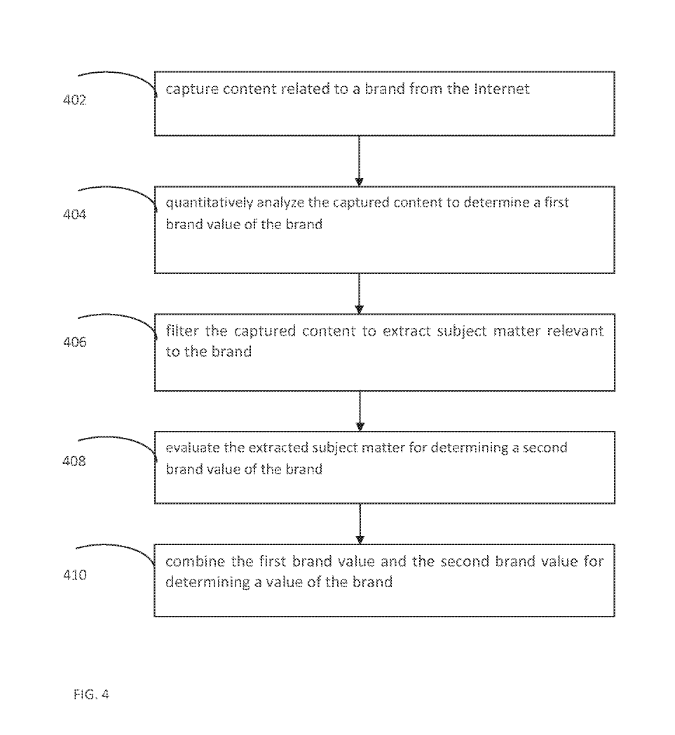

FIG. 4 illustrates a flow chart of a method for assessing value of a brand based on online content, according to an example. At block 402, content related to a brand is captured from the internet. In an implementation, a computer system accesses the internet to acquire online content related to a brand. Some non-limiting examples of online content (including “social media” resources) may include social networks, blogs, internet forums, wikis, weblogs, social blogs, and podcasts. Thus, in an example, a computer system may obtain news articles, analyst reports, stock market filings, blog comments, tweets, etc. which may he relevant to a brand. Any online content which mentions, discusses, comments, remarks, or provides any reference or observation pertaining to a brand, brand's owner, brand's competitor, or brand's industry may be construed as “related” or relevant to a brand. In an implementation, a user may select the brand for searching related content online. For example, a user may choose to search and capture content related to “Hewlett-Packard”. In another case, a search for content related to a brand may be predefined in a system. The captured content may be stored on the computer system used for searching and capturing online content related to a brand, or in another computer system.

At block 404, captured content is quantitatively analyzed for determining a first brand value of the brand. Quantitative analysis involves obtaining various kinds of metrics (i.e. measures that facilitates the quantification of some particular characteristic) related to the captured content. Some non-limiting examples of quantitative analysis which may be performed on the captured content (related to a brand) include a “Share of Voice” analysis of the brand, a count of Tweets or re-Tweets containing a Uniform Resource Locator (URL) of a specific blog about the brand, a count of web page views containing content related to the brand, a count of “likes” related the brand, and comments on a blog related to the brand. Quantitative analysis of the captured content determines a first brand value of the brand which may be any, all, or a combination of aforesaid metric(s).

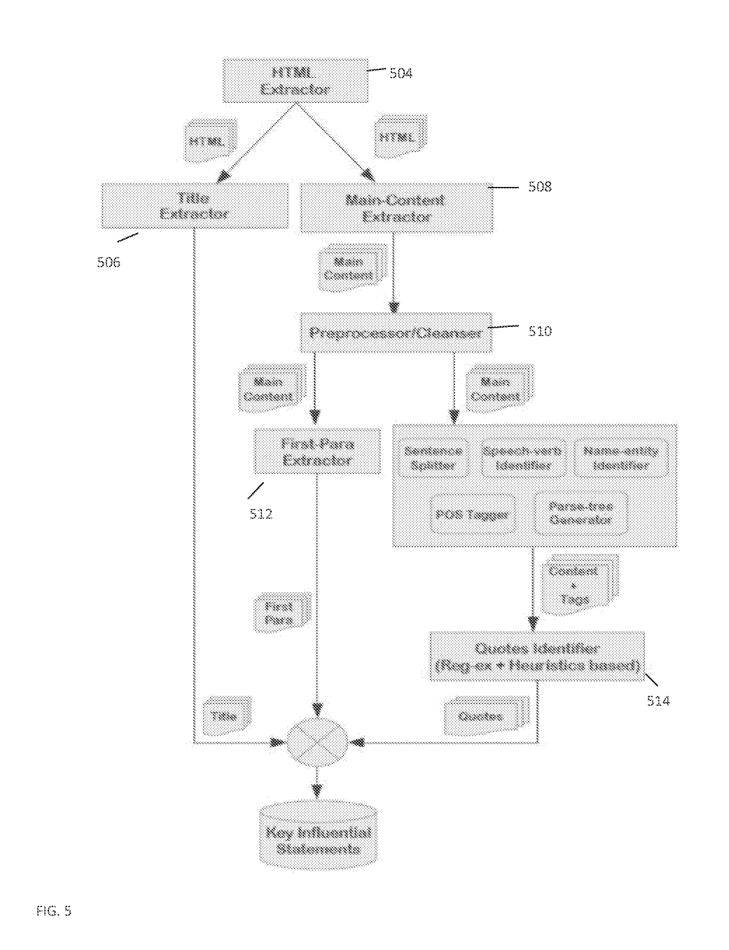

At block 406, captured content is filtered to extract subject matter relevant to a brand. Sometimes the entire captured content may not be relevant to a brand. For instance, a news article may only include a passing reference (such as a sentence) to the brand under investigation. The remaining subject matter may not be related to the brand. In such instance, captured content may be filtered to extract subject matter relevant to a brand. In another example scenario, captured content may contain certain statements or sections that may tend to influence the minds of a reader in creating a certain brand value (for example, certain statements create an impression of a brand being ‘innovative’). In such cases, captured content may be filtered to extract like statements. Filtering helps in identifying key influential statements from captured content. Such statements tend to be influential to a reader's mind because of their semantic attributes and are likely to influence an individual's perception of a brand. Some non-limiting examples of key influential statements which may be extracted from captured content may include: (a) the title of the article, (b) the first paragraph of the article, which is by itself a summary of the article and is meant to not only provide a glimpse of the article, but also generate the interest of the reader regarding the news, (c) quotes from influential persons associated with the brand, which often crisply communicates the value add to the end customer, and also add an overall credibility to the promotion, (d) statements that compare a brand's product with competitor products, and (e) statements that describe future plans of the business. FIG. 5 illustrates the architecture of a filtering module which may be used to extract key influential statements related to a brand) from online captured content, according to an example.

Filtering module 502 comprises HyperText Markup Language (HTML) extractor module 504, title extractor module 506, main-content extractor module 508, pre-processor module 510, first-para extractor module 512, and quote identifier module 514. In an implementation, a set of Uniform Resource Locators (URLs) extracted from a web search engine which is specialized to search news articles, blogs, analyst reports, etc. is provided as an input to filtering module 502. HTML extractor module 504 extracts the HTML content from each URL (employing tools such as, urllib2 library for Python). The HTML content is provided as an input to title extractor module 506 that may employ HTML parser tools (such as, BeautifulSoup & lxml libraries for Python) to extract the title of an article. The HTML content is also provided as an input, in parallel, to main-content extractor module 508, which extracts the most significant content of the article (employing tools such as, Boilerpipe library). The main content of the article, thus extracted, is provided as input to pre-processor (or cleanser module 510, which cleanses the article. In an implementation, cleaning of an article is performed in the following manner: (a) filter out short sentences (<50 characters) which do not end with a legitimate end of sentence punctuation mark, a period (.), a question mark (?) or an exclamation point (!), (b) filter very long sentences (>1000 characters) (for example, legal disclaimers that are not useful in the present context can be filtered out), and (c) convert Unicode quotes to ASCII quotes (for a uniform way of pattern matching).

The processed or cleansed main content of the article is then provided as an input to first-para extractor module 512 which extracts the first paragraph of the article. Simultaneously, the main content is subjected to a set of Natural Language Processing (NLP) pre-processing steps namely: (a) Sentence splitting, (b) POS tagging, (c) Parse tree generation, (d) Named entity recognition, and (e) Speech verb identification which detects the presence of a speech verb like, ‘said’, ‘explained’, ‘commented’ etc. from a gazetteer list of verbs. The output of this pre-processing step is a set of tagged sentences.

Quote identifier module 514 uses a combination of regular-expression (for example, written using POS/Parse tree tags) based rules and heuristics to identify the quoted sentences in an article.

The output from title extractor module 506, first-para extractor module 512 & quote identifier module 514 is combined to obtain key influential statements. Such key influential statements thus form the subject matter relevant to a brand which is extracted from captured content upon filtration.

At block 408, the extracted subject matter is evaluated against a predefined brand assessment attribute for determining a second brand value of the brand. In other words, key influential statements extracted from captured content are compared against an attribute(s) which provides an assessment of a characteristic or quality related to a brand. Some non-limiting examples of predefined brand assessment attribute include: (a) innovative (b) cost-effective (c) premium (d) quality conscious (e) customer centric (f) trustworthy (g) collaborative and (h) green.

In an implementation, crowdsourcing is used to carry out the evaluation of an extracted subject matter against a predefined brand assessment attribute for determining a second brand value of the brand. As generally known, in crowdsourcing, a task is outsourced to an unknown group of people (typically called “crowdsourced agents”) who are asked to submit solutions. The solutions are typically owned by the individual or enterprise that outsourced the task.

In the present context, crowdsourcing offers an advantage in performing an evaluation of an extracted subject matter against a predefined brand assessment attribute. It is a well known fact that people carry prior impressions or biases regarding popular brand names. To leverage this point for assessing the implicit brand value, two types of crowd based analyses are performed. In the first analysis, all occurrences of brand names present in the extracted content (for example, key influential statements) are masked using fictitious or anonymous names and the anonymized text is posted to a group of users (“the crowd”) to determine a Brand-agnostic Impact Index (Ball). In the second analysis, the extracted content is posted as is (without anonymization) to the crowd to determine the Brand-aware Impact Index (BwII). The difference in the two evaluated metrics provides an insight into the implicit brand impression i.e. “Brand Impression” value (or a second brand value) that the crowd carries.

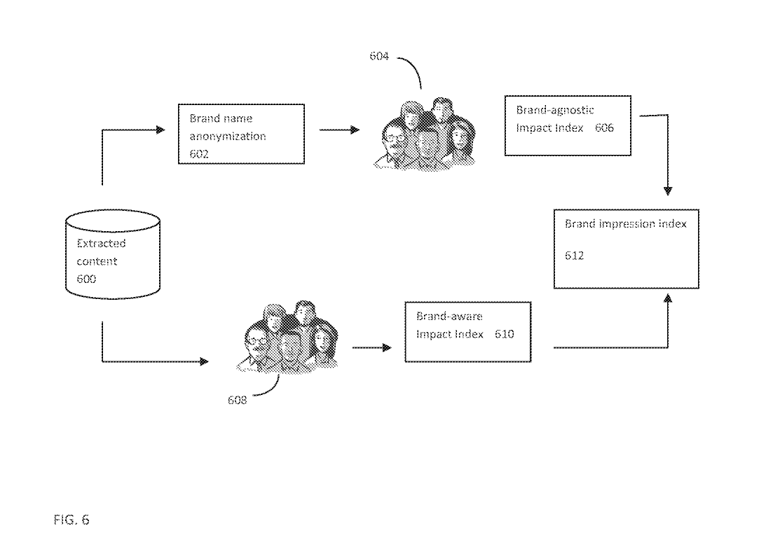

FIG. 6 illustrates determination of a second brand value of a brand, according to an example. In an implementation, Brand-agnostic Impact Index (Ball) 606 may be determined by anonymizing (hiding) the name of the brand 602 under assessment in the extracted content 600 (for example, key influential statements). Anonymized extracted content is shared with a crowd 604 (i.e. crowdsourced) to analyze and rate the effect of the impressions of various value-adding attributes of the brand (examples mentioned earlier) that the extract creates on the minds of the reader. For each attribute of the brand, a user (or an individual in a crowd) chooses a value from 0 to 5, wherein a value of 0 indicates the least effect of the impression and a value of 5 indicates maximum effect of the impression. This value is called the ‘Brand-agnostic Impact Index’ 606 (Ball), because the crowd is not aware of the brand that the extract belongs to when analyzing the message. Thus, Ball 606 indicates the effect of the messaging (or communication) in creating brand impressions, without considering the historical biases of crowd.

A Ball value is indicative of the effect of the structure and wordings of the message. The terms used in the message and the manner in which a fact is conveyed guides the crowd in analyzing the impressions. Since the Ball does not depend on prior human knowledge of brands, and is purely determined based on natural language used, a machine learning classifier can be trained to accept key influential sentences as input and estimate the Ball as output. The first set of answers from the crowd can be used as a training dataset to train the machine classifier, and subsequent answers are derived directly from the trained machine classifier.

A Brand-aware Impact Index (BwII) 610 may be determined by providing or sharing the extracted content 600 (key influential statements) with a crowd 608. As in the case of Ball, the crowd 608 is requested to analyze and rate (in the same scale of 0 to 5) the effect of the impressions of the brand attributes that the extract creates on the minds of the reader. This value is called the ‘Brand-aware Impact Index’ 610 (BwII), because the crowd is aware of the brand that the extract belongs to (brand name is visible) and hence is free to let their prior biases affect their analysis. The BwII 610 indicates the combined effect of the prior biases regarding the brand and the effectiveness of the messaging in creating brand impressions.

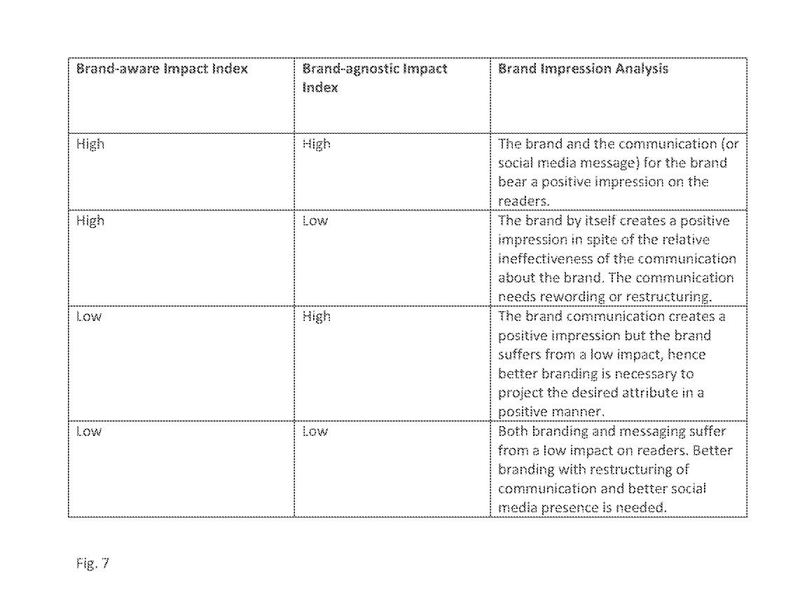

The difference between the BwII and the Ball provides a second brand value of the brand or a “Brand Impression” value or index 612. The brand impression value is derived qualitatively by comparing the impact index values of brand-aware messaging and the brand-agnostic messaging (BwII and Ball). For these metrics, a value of 3-5 may be considered as high whereas a value of 0-2 may be considered low. FIG. 7 illustrates a table summarizing the brand impression analysis based on metric values, according to an example.

At block 410, a first brand value of the brand and a second brand value of the brand are aggregated for determining an “overall” value of the brand. In other words, the value of a brand after carrying out a quantitative analysis of the captured content is combined with brand impression value (as obtained above) to determine an inclusive or complete value of the brand.

Solution described in this application may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising transitory or non-transitory processor-readable media for carrying or having computer-executable instructions or data structures stored thereon. Such processor-readable media can be any available media that can be accessed by a general purpose or special purpose computer. By way of example, such processor-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of assessing value of a brand based on online content, comprising:
capturing content related to the brand from the internet;
quantitatively analyzing the captured content for determining a first brand value of the brand;
filtering the captured content to extract subject matter relevant to the brand;
evaluating the extracted subject matter for determining a second brand value of the brand; and
combining the first brand value and the second brand value for determining the value of the brand.

2. The method of claim 1, wherein the content related to the brand is social media content.

3. The method of claim 2, wherein the social media content includes content from one of the following: social networks, blogs, internet forums, wilds, weblogs, social blogs, and podcasts.

4. The method of claim 1, wherein type of the social media content is defined by a user.

5. The method of claim 1, wherein quantitatively analyzing the captured content includes determining one of the following: a Share of Voice of the brand, a count of Tweets or re-Tweets containing a Uniform Resource Locator (URL) of a specific blog about the brand, a count of web page views containing content related to the brand, a count of “likes” related the brand, and comments on a blog related to the brand.

6. The method of claim 1, wherein filtering comprises extracting subject matter likely to influence an individual's perception of the brand.

7. The method of claim 1, wherein the extracted subject matter is evaluated against the predefined brand assessment attribute through crowdsourcing.

8. The method of claim 1, wherein the extracted subject matter is evaluated against a predefined brand assessment attribute for determining a second brand value of the brand.

9. The method of claim 8, wherein the predefined brand assessment attribute includes one of the following: innovative, cost-effective, premium, quality conscious, customer centric, trustworthy, collaborative, and green.

10. The method of claim 1, wherein the evaluation comprises receiving a user's rating on the predefined brand assessment attribute.

11. The method of claim 1, wherein the evaluation comprises capturing a user's rating of the predefined brand assessment attribute wherein name of the brand is hidden from the user in the extracted subject matter.

12. The method of claim 1, wherein the evaluation comprises capturing a user's rating of the predefined brand assessment attribute wherein name of the brand is visible to the user in the extracted subject matter.

13. The method of claim 1, wherein the second brand value of the brand is determined by combining an individual's rating of the predefined brand assessment attribute wherein name of the brand is hidden from the individual in the extracted subject matter with the individual's rating of the predefined brand assessment attribute wherein name of the brand is visible to the individual in the extracted subject matter.

14. A system, comprising:
a quantitative module to quantitatively analyze content related to a brand in order to determine a first brand value of the brand;
a filtering module to extract subject matter relevant to the brand from the captured content;
an analyzer module to evaluate the extracted subject matter against a predefined brand assessment attribute in order to determine a second brand value of the brand; and
an aggregation module to combine the first brand value and the second brand value in order to determine a complete value of the brand.

15. The system of claim 14, wherein the content related to the brand is acquired from social media on the internet.
